(19) United States
(12) Patent Application Publication
(10) Pub. No.: US 2025/0172442 A1
(43) Pub. Date: May 29, 2025

(54) MOVEABLE TIP AND INSTALLATION CONFIGURATION FOR FIBER OPTIC TEMPERATURE SENSING PROBE

(71) Applicant: Photon Control, Inc., Richmond (CA)

(72) Inventors: Yi LIU, Richmond (CA); Min ZHU, Richmond (CA); Jamie MUNN, Richmond (CA)

(73) Assignee: Photon Control Inc, Richmond, BC (CA)

(21) Appl. No.: 18/840,181

(22) PCT Filed: Feb. 22, 2023
(86) PCT No.: PCT/CA2023/050222

§ 371 Date: Aug. 21, 2024

Related U.S. Application Data
(60) Provisional application No. 63/268,345, filed on Feb. 22, 2022.

(51) Int. Cl. G01K 11/3213; G01K 1/143; G01K 1/16

(52) U.S. Cl. CPC G01K 11/3213; G01K 1/143; G01K 1/16

(57) ABSTRACT

A fiber optic temperature sensing probe is described. The probe includes a probe shaft comprising a first portion comprising a first projection, and a cavity for having a fiber optic cable positioned therein. The probe includes a ferrule comprising a second projection, the second projecting cooperating with the first projection to prevent the ferrule and probe shaft from uncoupling from an assembled configuration. The probe includes a biasing member connected to, and encouraging displacement between, the ferrule and the first portion, The probe includes a sensing element positioned at a distal end of the ferrule and proximate to a surface to be measured, the sensing element configured to interact with light received from the fiber optic cable to measure a temperature of the surface to be measured.

### CROSS-REFERENCE TO RELATED APPLICATION(S)

This application claims priority to U.S. Provisional Patent Application No. 63/268,345 filed on Feb. 22, 2022, the contents of which are incorporated herein by reference in their entirety.

### TECHNICAL FIELD

The following generally relates to sensing probes such as fiber optic temperature sensing probes used to measure the temperature of a surface, and more particularly to adjustable sensing probes.

### BACKGROUND

Fiber optic temperature sensors, such as temperature probes, normally include optical fiber(s) which can deliver light to a sensing material (e.g., phosphor). The light illuminates the phosphor which, in turn, luminesces. The temperature of the phosphor can be determined by observing the changes in certain characteristics of the emitted light. Differences in temperature between the phosphor and the surface to be measured (i.e., the target surface) can create difficulties in calibrating the sensor to obtain accurate measurements.

Generally, a fiber optic temperature probe includes a base and a single tube extending therefrom within which an optical fiber is positioned. A sensing tip including the sensing material is attached to an end of the tube to contact the target surface. The tube is intended to provide the probe with mechanical strength and resistance to environmental conditions, while ideally reducing heat loss from the tip to maintain the sensing material as close to the temperature of the target surface as possible. To facilitate processes such as dry etching, in which materials are etched with corrosive chemicals under high temperature, the tube should be resistant to high temperatures and corrosion in addition to having the above qualities, making material selection challenging.

Sensing tips are typically rigidly aligned with their target surface and thus there is often a small angle preventing flush contact between the surfaces, particularly when a smooth, solid surface is being measured. Poor contact between the target surface and the tip of the sensor can reduce the rate of heat transfer between the target surface and the tip, thereby slowing temperature measurements. Poor contact may also introduce additional thermal resistance, resulting in an offset between the measured and actual temperature.

Temperature probe sensing tips may also be rigidly fixed to the tube using a bonding or mechanical structure. These configurations are known to create undesirable, and potentially problematic stresses on the components during both installation and use of the probe. Moreover, some applications include relatively small areas in which to install the probe, which can create difficulties during installation.

### SUMMARY

In one aspect, a fiber optic temperature sensing probe is described. The probe includes a probe shaft comprising a first portion comprising a first projection, and a cavity for having a fiber optic cable positioned therein. The probe includes a ferrule comprising a second projection, the second projecting cooperating with the first projection to prevent the ferrule and probe shaft from uncoupling from an assembled configuration. The probe includes a biasing member connected to, and encouraging displacement between, the ferrule and the first portion, The probe includes a sensing element positioned at a distal end of the ferrule and proximate to a surface to be measured, the sensing element configured to interact with light received from the fiber optic cable to measure a temperature of the surface to be measured.

In example embodiments, the sensing element snap-in fits with, or includes threading complementary to threading proximate to, an opening of the ferrule. In example embodiments, the opening has a chamfered lip to facilitate the snap-in fit of the sensing element.

In example embodiments, the second projection includes a chamfered lip to generate a snap-in fit with the first projection.

In example embodiments, the ferrule includes a first chamber extending from the sensing element to a wider second chamber thereby defining a shoulder, the shoulder restricting movement of the first projection towards the sensing element. In example embodiments, a minimum distance between the sensing element and the probe shaft in an optical axis is defined by the shoulder.

In example embodiments, the second projection includes an inner chamfer to interface with a rear shoulder of the first portion to impede disassembly of the probe shaft and the ferrule.

In example embodiments, the ferrule or the sensing element is coupled to the surface to be measured.

In example embodiments, a base portion of the probe shaft engages a seal to form a vacuum seal between the probe shaft and the surface to be measured. In example embodiments, the base portion of the probe shaft is separable from the first portion.

In example embodiments, the ferrule includes at least a first ferrule part and a second ferrule part different from the first ferrule part. In example embodiments, the first ferrule part can rotate with respect to the second ferrule part, or rotate with respect to the probe shaft.

In example embodiments, the probe further includes a seal, the seal interacting with a wall and the probe shaft to generate a vacuum seal.

In example embodiments, the sensing element includes one or more of diamond, aluminum, copper, gold, nickel or nickel alloy, aluminum nitride, and silicon carbide.

In example embodiments, a contact area between the sensing element and the ferrule is less than 2 mm², or less than 1 mm², or less than 0.5 mm², or less than 0.25 mm².

In example embodiments, the sensing element has a thermal conductivity greater than 20 W/m−1K, or greater than 150 W m−1/K, or greater than 225 W m−1/K, or greater than 300 W m−1/K.

In another aspect a fiber optic temperature sensing system is disclosed. The system includes a probe body. The probe body includes a base portion, a body extending from the base portion and terminating at a head portion, a passage through the base portion and the probe body, and a fiber optic cable within the passage. The system includes at least one ferrule including a first opening at a first end, the first opening providing a snap-in or threaded-in fit with the head portion. The system includes a biasing member positioned to apply force to the at least one ferrule towards a surface to be measured, and a sensing element positioned at a second end of the at least one ferrule, opposite the first end, the sensing element comprising a sensing material for interacting with light from the fiber optic cable positioned in the passage.

In example embodiments, wherein the sensing material is coupled to the surface to be measured.

In another aspect, a method of assembling a fiber optic temperature sensing probe is disclosed. The method includes providing a first part and a second part of a probe shaft, the first and second parts of the probe shaft including passages configured to receive fiber optic cables. The method includes providing a first fiber optic cable and a second fiber optic cable, and inserting the first fiber optic cable into the first part of the probe shaft. The method includes inserting the second fiber optic cable into the second part of the probe shaft, and providing a block. The method includes providing a cap, connecting the first part of the probe shaft to the block, and connecting the second part of the probe shaft within the cap. The method includes assembling the block to the cap, optically aligning the respective fiber optic cables of the first part of the probe shaft and the second part of the probe shaft.

In example embodiments, connecting the first part of the probe shaft to the block includes sealing the first part of the probe shaft to the block with a seal. In example embodiments, the first part of the probe shaft comprises a ferrule, the ferrule comprises at least a first ferrule part and a second ferrule part different from the first ferrule part and the first ferrule part is configured to rotate with respect to the second ferrule part, or rotate with respect to the probe shaft. In example embodiments, the first part of the probe shaft comprises a ferrule, the ferrule comprises at least a first ferrule part and a second ferrule part different from the first ferrule part and the first ferrule part is configured to rotate with respect to the first part of the probe shaft.

### BRIEF DESCRIPTION OF THE DRAWINGS

Embodiments will now be described with reference to the appended drawings wherein:

FIG. 1A is a cross-section view of a fiber optic temperature probe supported within a mounting block adjacent an object to be measured.

FIG. 1B is a cross-section view of a fiber optic temperature probe consisting of two separable portions.

FIG. 1C is a cross-section view of an example fiber optic temperature probe supported, and sealed, within a mounting block.

FIG. 1D is a cross-section view of another example fiber optic temperature probe supported, and sealed, within a mounting block.

FIG. 2 is a perspective view of the fiber optic temperature probe of FIG. 1A.

FIG. 3 is a cross-section view of a ferrule coupled to the distal end of the fiber optic temperature probe of FIG. 1A.

FIGS. 4 and 5 are side views showing axial movement of an example temperature probe shaft relative to a ferrule.

FIGS. 6 and 7 are perspective views showing axial movement of an example temperature probe shaft relative to a ferrule.

FIG. 8 illustrates a configuration of an example temperature probe having an integrated ferrule and sensing element.

FIG. 9 illustrates a configuration of the temperature probe coupled directly to the measured object.

FIG. 10 illustrates a configuration of an example temperature probe with limited axial movement of the probe shaft relative to the ferrule.

FIG. 11A is a cross-section view of an example fiber optic temperature probe and a two-part ferrule.

FIG. 11B is another cross-section view of the example fiber optic temperature probe of FIG. 11A in an adjusted configuration.

### DETAILED DESCRIPTION

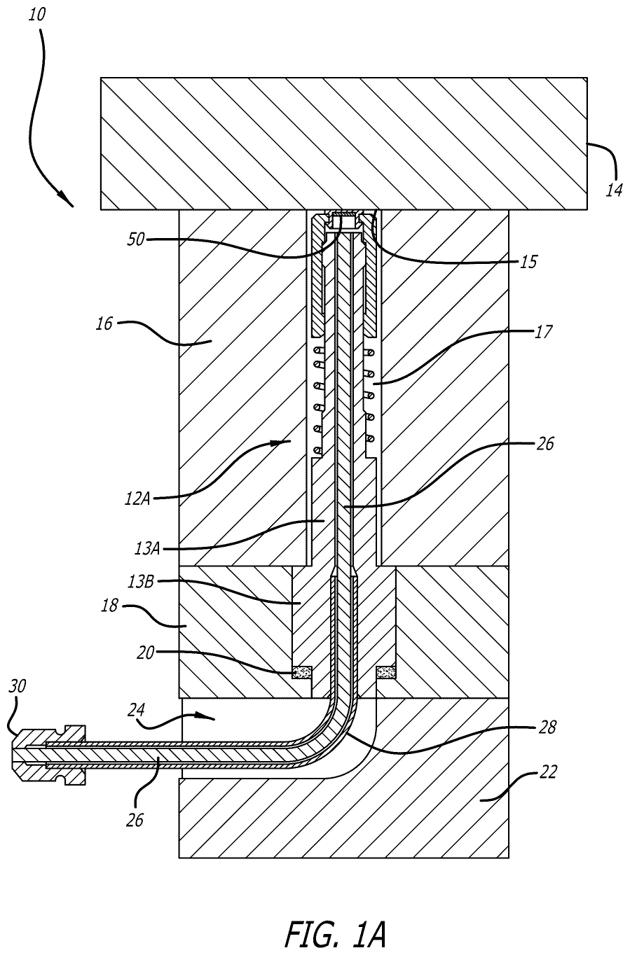

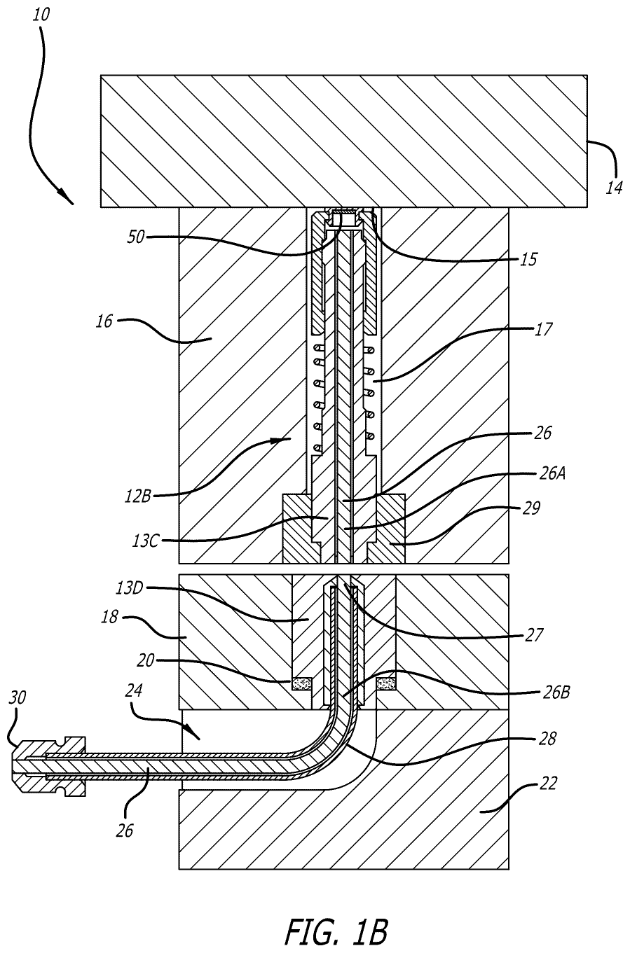

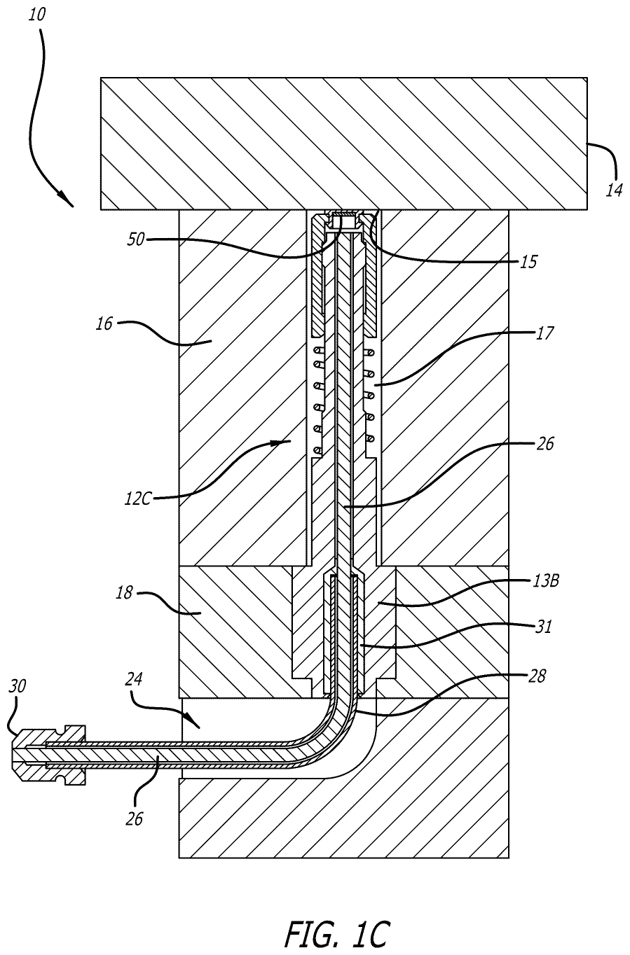

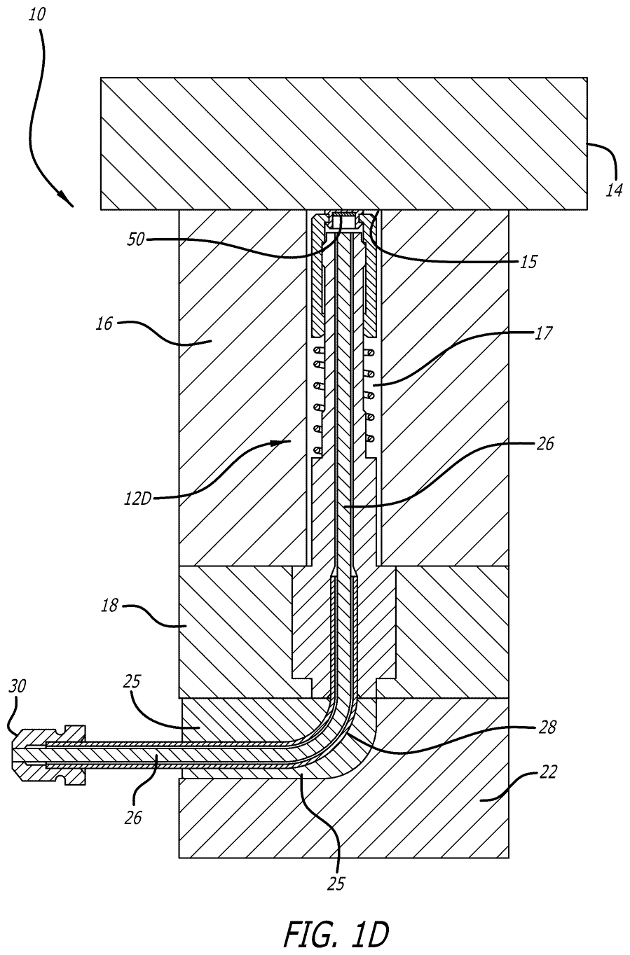

Turning now to the figures, FIG. 1A illustrates a sensing environment, in this example an environment 10, in which a fiber optic temperature probe 12A is used to measure the temperature of an object 14 through contact with a surface 15 of the object 14. The object 14 can be any component or structure providing a contact surface for which a temperature measurement is desired, e.g., an electrostatic chuck in a semiconductor chamber. The temperature probe 12A is connected to, or supported against, or otherwise adjacent to, or near, the measured object 14 by way of a support block 16. The support block 16 includes a passage 17 that is sized and configured to enable the probe 12A to be inserted and positioned therein. Positioned in passage 17, the probe 12A can be advanced towards and into engagement with an exposed surface 15 of the measured object 14 such that the probe 12A can contact the measured object 14 to permit temperature sensing as explained in greater detail below.

In the shown example, the temperature probe 12A is fitted into a cap block 18 by way of an O-ring 20. Other sealing mechanisms may be contemplated. A transition block 22 is secured to the cap block 18 and together the cap and transition blocks 18, 22 define a passage 24 through which a cable 26 (e.g., a fiber optic cable, and hereinafter referred to as optic cable 26 for ease of reference) can pass It can be appreciated that the delineation between the cap and transition blocks 18, and 22, respectively, in FIG. 1A is illustrative and other configurations are possible, such as transition block 22 extending up to block 16 in a unitary piece. Shown in FIG. 1A is a connector 30 for connecting the optic cable 26 to a unit that provides the excitation light and analyzes the emitted light to provide temperature information, also called a converter or sensing unit. In the shown example, the optic cable 26 includes a relatively sharp (i.e., substantially ninety degree) bend into the cap block 18, and is protected by a jacket 28. While FIG. 1A shows transition block 22 and cap block 18 as separate components, in other embodiments transition block 22 and cap block 18 may be a single component. In example embodiments, the different blocks are connected to different portions of the probe 12A. For example, the cap block 18 can be connected to second portion 13B, while the block 16 can be connected to the first portion 13A. In various example embodiments, temperature probe 12A may be installed in cap block 18 and transition block 22 before installation of support block 16; in other embodiments the installation process can occur in a different order and/or with fewer or additional components.

It can be appreciated that in an environment having a sharp bend in the optic cable 26, a bundle of thin optical fibers can be used to permit bending. In various example embodiments, at least a portion of optic cable 26 may include one or more plastic fibers or one or more glass fibers or one or more silica fibers. For example, the individual fibers in such a bundle can slide relative to each other to accommodate bends more readily, and with reduced stress. In various example embodiments, the radius of curvature of the flexible portion of optic cable 26 can be less than about 50 mm, or less than about 25 mm, or less than about 15 mm, or less than about 5 mm. It can also be appreciated that the sensing environment 10 shown in FIG. 1A is illustrative of one example application of the temperature probe 12A, and the principles discussed herein are equally applicable to other environments and applications.

FIG. 1B depicts another exemplary temperature probe, denoted incrementally as 12B. A second portion 13D of the temperature probe 12B is similar to the second portion 13B of the probe 12A described in reference to FIG. 1A. The temperature probe 12B includes a first portion 13C different than a first portion 13A of probe 12A (FIG. 1A). Hereinafter, first portions 13A and 13C, and second portions 13B and 13D, are alternatively referred to as upper, and lower portions, for ease of reference. The upper portion 13C is configured to be attached or mechanically coupled to support block 16. Similarly, in the shown embodiment the lower portion 13D can be configured to be attached, or mechanically coupled, to cap and transition blocks 18 and/or 22, respectively.

Upper and lower portions 13C and 13D can be separable and resealable (e.g., via mechanical couplings such as complementary fasteners, etc.), and the optic cable 26 can relatedly be separated into an upper cable portion 26A and a lower cable portion 26B. For example, the upper and lower portions 13C and 13D can include mating mechanical features, such as complementary threading, which permit the portions to engage and be assembled and separated. In other embodiments, upper and lower portions 13C and 13D may be configured to be positioned within cap and transition blocks 16 and 18, respectively such that they are not mechanically coupled but that the optical axes of cable portions 26A and 26B are colinear.

As alluded to above, one or more alignment features can be used to assemble the upper and lower portions 13C and 13D. The alignment features can enable (re) sealing and separation of portions 13C and 13D, and also (or in the alternative) facilitate optically aligning the ends of cable portions 26A and 26B. The alignment feature can be on either or both of portions 13C, and 13D. In respect of alignment, in various example embodiments, the optical co-linearity (the distance between the respective optical axes of the cable portions 26A, 26B, where an optical axis is defined by a direction of light exiting or entering the end of the optical fiber portion) between cable portions 26A, 26B may be less than 0.5 mm, or less than 0.25 mm or less than 0.1 mm, or less than 0.05 mm. In various example embodiments, the alignment feature(s) is one or more fastener(s) 29 that interacts with portions 13C, and/or 13D, and at least in part fixes the probe 12B with respect to one of the support block 16 or cap and transition blocks 18, 22, respectively. Example fasteners 29 can include adhesives, mechanical fasteners, etc.

The portions 13C and 13D can also be sealed with respect to the support block 16 or cap and transition block 18, 22. For example, a seal may be formed between upper portion 13C and support block 16 using an O-ring. In example embodiments, the alignment features at least in part responsible for sealing the portions to one of the blocks. In various embodiments such a seal may be a vacuum seal, for example to prevent a leak from within passage 17 to the exterior ambient.

For clarity, in an assembled configuration, the portions 13C and 13D allow light to pass bidirectionally between the cable portions 26A, 26B. The assembled configuration can include the cable portions 26A and 26B contacting one another, or the cable portions 26A and 26B being separated by a gap 27 that enables the cable portions 26A and 26B to pass light bidirectionally between themselves.

In example embodiments, the probe 12B can be assembled in a variety of different manners. For example, upper portion 13C can be attached to support block 16. This may permit installation of the lower portion 13D in cap and transition blocks 18 and 22, and separate installation of portion 13C in support block 16, such that support block 16 and cap and transition blocks 18, and 22 may be physically separated and mated without requiring additional support of either portions 13C and 13D and while providing optical alignment of cable portions 26A, 26B.

Temperature probes disclosed herein can be configured for ambient pressures less than atmospheric pressure. FIG. 1C and FIG. 1D depict exemplary temperature probes 12C and 12D, respectively, for use in ambient pressures at or less than atmospheric pressure. It is understood that alternative systems with similar functionality are also contemplated. For example, the temperature probe 12C (FIG. 1C) may be configured to operate at pressures less than about 1E-3 torr, or less than about 1E-4 torr or less than about 1E-6 torr.

Temperature probe 12C includes a seal 31 between optic cable 26 and lower portion 13B. For example, the seal 31 can be a metal seal (e.g., a metal seal enclosing opposing ends of a cavity), an adhesive (e.g., an epoxy or ceramic adhesive), a radial seal, or other seal, such as O-ring(s) on an end(s) of a gap between the optic cable 26 and the lower portion 13B. In at least some example embodiments, the assembled configuration of probe 12C includes a seal (not shown) between the lower portion 13B and cap block 18, similar to the seal 31 between the optic cable 26 and the lower portion 13B. In example embodiments, the seal 31 includes, or generates, a vacuum sealed cavity. Various methods of realizing the seal 31 are contemplated. It is understood that the term seal does not require a perfect seal. For example, the seal 31 may have a leak rate less than about 1E-8 torr-I/sec, or less than about 1E-9 torr-I/sec or less than about 1E-10 torr-I/sec.

A probe according to the disclosed embodiments can be sealed in cooperation with various features of the blocks 16, 18 and 22. For example, FIG. 1D depicts the temperature probe 12D at least in part sealed between the surface 15 and the blocks 16, 18 and 22 by a potting compound 25 surrounding the optic cable 26, where the potting compound 25 is within the passage 24 (FIG. 1C).

It is understood that the probes 12A, 12B, 12C, and 12D, depicted in FIGS. 1A, 1B, 1C, and 1D, can be configured to operate without seals, with the seal combinations shown therein, or with various combinations of seals, or with seals different than the shown seal(s). For example, while O-ring 20 is depicted in FIG. 1A and FIG. 1B as providing a face seal, in other embodiments, seals with different geometries such as radial seals or other types of sealing may be used.

Different sizing of probes and cables is contemplated. For example, referring to FIG. 1A, in various embodiments, the upper portion 13A may have a diameter less than about 40 mm, or less than about 25 mm, or less than about 10 mm. In various embodiments the optic cable 26 may have a diameter less than about 5 mm, or less than about 3 mm, or less than about 1 mm. In various embodiments, the length of the temperature probe 12A positioned in the support block 16 may be less than about 400 mm, less than about 100 mm, or less than about 50 mm.

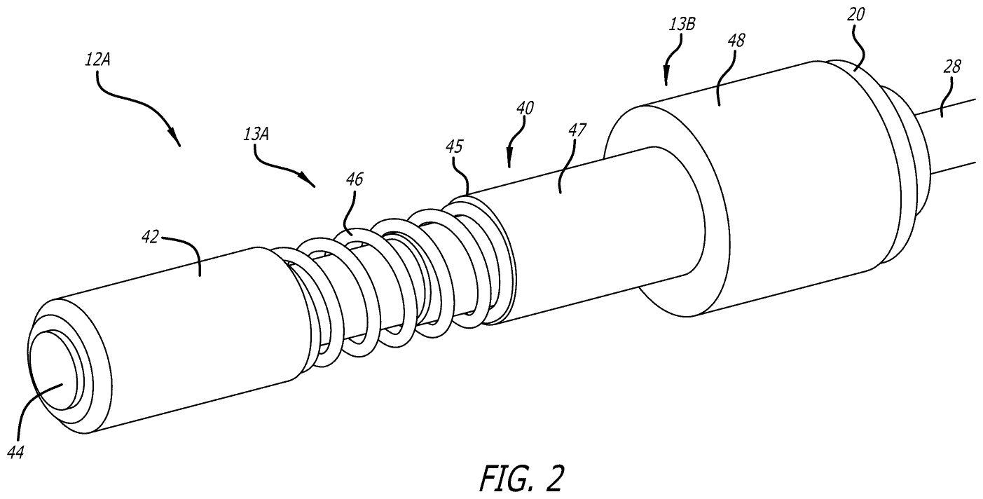

FIG. 2 illustrates a perspective view of the temperature probe 12A. The probe 12A includes a shaft 40 having the upper portion 13A and the lower portion 13B. The shaft 40 includes a connector portion 48 (alternatively referred to as a base portion 48) of the lower portion 13B that supports the O-ring 20 to connect the probe 12A to, for example, the cap block 18 shown in FIGS. 1A-1D. However, the connector portion 48 can also be suitably adapted to fit with or in other structures, and may or may not require the O-ring 20 to do so. The connector portion 48 is also coupled to the jacket 28 where the fiber optic cable 26 enters the probe shaft 40. The upper portion 13A includes a stepped main body 47 extending from the connector portion 48 and includes an intermediate shoulder 45. The shoulder 45 provides a surface against which a biasing element such as the spring 46 can engage.

A ferrule 42 or other tubular component is assembled with, or attached to, or connected with the upper portion 13A (e.g., at a distal end of the shaft 40). The ferrule 42 can be composed of various materials depending on the application. For example, the ferrule 42 can include a high temperature plastic, a ferrous or non-ferrous metal, or a ceramic for particularly high temperature applications. The ferrule 42 provides an opposing surface against which the spring 46 can engage so as to bias (or displace) the ferrule 42 away from the base portion 48 to force a sensing element 44 against a surface, such as the surface 15 of the measured object 14 as shown in FIGS. 1A-1D. The sensing element 44 may also be referred to as a “button” or “tip”.

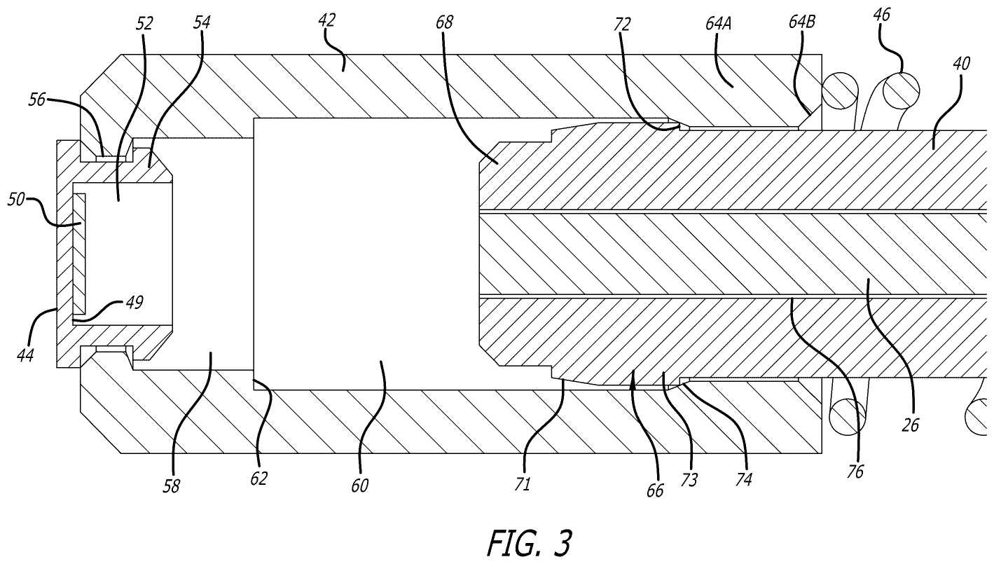

Referring now to FIG. 3, a cross-section view of the ferrule 42 and interacting components is shown. Beginning at the distal end of the ferrule 42 it can be seen that a chamfered opening 56 is provided to permit the sensing element 44 to snap into the opening 56. The sensing element 44 includes a circumferential lip 54 that is also chamfered at its leading end to facilitate insertion of the sensing element 44 into the opening 56 during installation. The lip 54 provides an orthogonal surface opposite the chamfered surface to hold the sensing element 44 in place once snapped into the ferrule 42. As best seen in FIG. 3, the sensing element 44 is an open ended structure and provides a cavity 52 to allow light to be transmitted from the optical fiber(s) of the optic cable 26 to a sensing material 50 of the sensing element 44 applied to the innermost surface 49 (alternatively referred to as the interior surface 49 of the sensing element 44) of the cavity 52. For clarity, that the sensing material 50 and the sensing element 44, can together be referred to as the sensing element 44, for simplicity, and the interior surface 49 is understood to include the sensing material 50, as discussed herein. The sensing material 50 is excited by light transmitted through the optical fibers. The sensing material 50 is advantageously a phosphorescent material, for example, phosphor-although other materials would be known to a person skilled in the art.

The ferrule 42 can be a tubular member or otherwise include a cavity or passage therethrough. In this example, the distal opening 56 leads to a first chamber 58. The first chamber 58 transitions to a wider second chamber 60 to define a shoulder 62. The second chamber 60 permits a head portion 66 of the probe shaft 40 to slide axially within the ferrule 42.

During assembly, the head portion 66 of the probe shaft 40 is inserted into the second chamber 60 by inserting outwardly facing projection(s) 73 (hereinafter referred to in the singular, for ease of reference) of the head portion 66 into an opening in the ferrule 42, the opening being defined at least in part by inwardly facing projection(s) 64A (hereinafter referred to in the singular, for ease of reference) in opposition to projection 73 to enable a snap-in fit. It is understood that the term projection can be defined at least in part by a direction radial to the optical path of the optic cable 26.

The projection 64A can include a chamfered inner surface 64B to facilitate the insertion of the projection 73 into the chamber 60. A chamfered extension 68 protrudes from the head portion 66 and is relatively narrower than the projection 73 to facilitate alignment of the probe shaft 40 and the opening defined by the chamfered surface 64B during assembly.

As alluded to above, the head portion 66 can include the projection 73 for impeding decoupling, or disassembly, of the probe shaft 40 from the ferrule 42. The projection 73 can include a polygonal outer surface to provide a snap-in feature to facilitate assembly of the sensing probe 12. For example, as shown in FIG. 3, this outer surface of the projection 73 can provide a front chamfered shoulder 71 to facilitate insertion of the head portion 66 into the opening of the ferrule 42. The outer surface of the projection 73 can also include a rear shoulder 72 that inhibits, but does not prevent, removal of the probe shaft 40 from the ferrule 42 by bearing against an inner chamfered surface 74 of the projection 64A. In this way, the ferrule 42 can be biased away from the base portion 48 of the probe shaft 40 under the influence of the spring 46 (or other biasing member) while the ferrule 42 is maintained in an assembled configuration with the probe shaft 40. The inner chamfered surface 74 can also enable the probe shaft 40 to be separated from the ferrule 42 during installation, assembly, testing, etc. For example, if the sensing material 50 needs to be changed, the ferrule 42 can be removed from the probe shaft 40 and then reattached after the sensing material 50 is replaced. The cross-section view in FIG. 3 also illustrates the passage of the optic cable 26 through a channel or bore within the probe shaft 40. As discussed above, the optic cable 26 can be embodied by a bundle of fibers and in this example can be contained with a PTFE sleeve 76 or other coating or sheath.

The assembly of the ferrule 42 and the probe shaft 40 facilitates transmitting light towards the sensing element 44. In various example embodiments, sensing element 44 may include or consist of a material having a relatively high thermal conductivity, for example diamond, aluminum, copper, gold, nickel or nickel alloy, aluminum nitride, silicon carbide or the like. In various example embodiments, sensing element 44 may have a thermal conductivity, greater than about 20 W/m−1K (e.g., using alumina), greater than about 150 W m−1/K, or greater than about 225 W m−1/K or greater than about 300 W m−1/K.

In various example embodiments, ferrule 42 and sensing element 44 may be configured to reduce the thermal conductivity between sensing element 44 and ferrule 42. For example, the contact area between sensing element 44 and ferrule 42 can be reduced, or an insulator (e.g., low-conductivity coating) can be applied to the surface of one or both materials to increase the thermal resistance between sensing element 44 and ferrule 42. In various example embodiments, the contact area between sensing element 44 and ferrule 42 may be less than about 2 mm², or less than about 1 mm², or less than about 0.5 mm², or less than about 0.25 mm².

In various example embodiments, ferrule 42 may include or be composed of glass, aluminum oxide, aluminum, copper, aluminum nitride, silicon carbide, zirconia, polyetheretherketone (PEEK), polyimide, polyamide-imide (PAI), polybenzimidazole (PBI), Ultem, or the like.

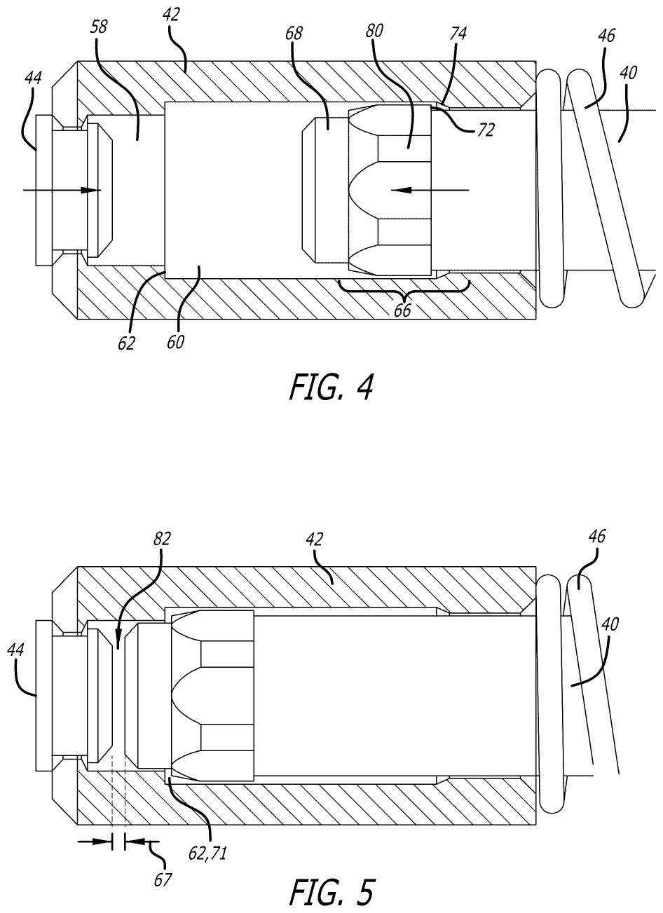

FIGS. 4 and 5 further illustrate the movement of the head portion 66 within the second chamber 60. FIG. 4 illustrates, using arrows, the snap in features that enable: i) the sensing element 44 to be installed on the ferrule 42, and ii) the probe shaft 40 to be inserted into the ferrule 42 or the ferrule 42 to be snapped onto the head portion 66 of the probe shaft 40 according to the assembly or installation being used. The snap-in features of the ferrule 42 therefore provide a quick connect system for the sensing probe 12 that greatly facilitates assembly, particularly in space-limited applications. In addition, the modularity of the disclosed probes facilitates the selection of different sensing elements 44, sensing material 50, upper and lower portions 13A and 13B, to respond to different environments and operating conditions. For example, one portion of the probe can be selected for the ability to withstand corrosion that results from use in an etching application, while another portion can be selected for its mechanical strength, while the sensing material can be selected based on a desired accuracy, etc.

FIG. 4 also illustrates further detail of the outer surface of the head portion 66. In this example, the polygonal outer surface defines a series of circumferentially spaced ridges 80 that provide relief for the snap-in action when the head portion 66 is inserted into the ferrule 42 or the ferrule 42 is snapped onto the head portion 66. This can reduce the stresses on the ferrule 42 during installation.

As seen in FIG. 5, when the ferrule 42 is pushed further down the probe shaft 40 (or the probe shaft 40 is positioned within the ferrule 42 to a maximum extent), the shoulder 62 positioned at the interface between the first and second chambers 58, 60 prevents the extension 68 from contacting the sensing element 44, e.g., to prevent the probe shaft 40 from decoupling or otherwise snapping the sensing element 44 off from the ferrule 42. For clarity, the ferrule 42 can be sized with a shoulder 62 such that a minimum distance 67 (i.e., a depth of gap 82) is maintained between the ends of the shaft 40 and the sensing element 44. That is, the gap 82 between the sensing element 44 and the extension 68 is enforced by the shoulder 62. It can be appreciated that the gap 82 and depth of the cavity 52 (shown in FIG. 3) in the sensing element 44 can vary based on a desired distance between the sensing material 50 and the end of the optic cable 26. Similarly, the length of the extension 68 and the depth of the first chamber 58 can vary to influence or otherwise contribute to this desired distance. In at least some example embodiments, the gaps 82 depth is less than about 20 mm, or less than about 10 mm, or less than about 5 mm, or less than about 1 mm.

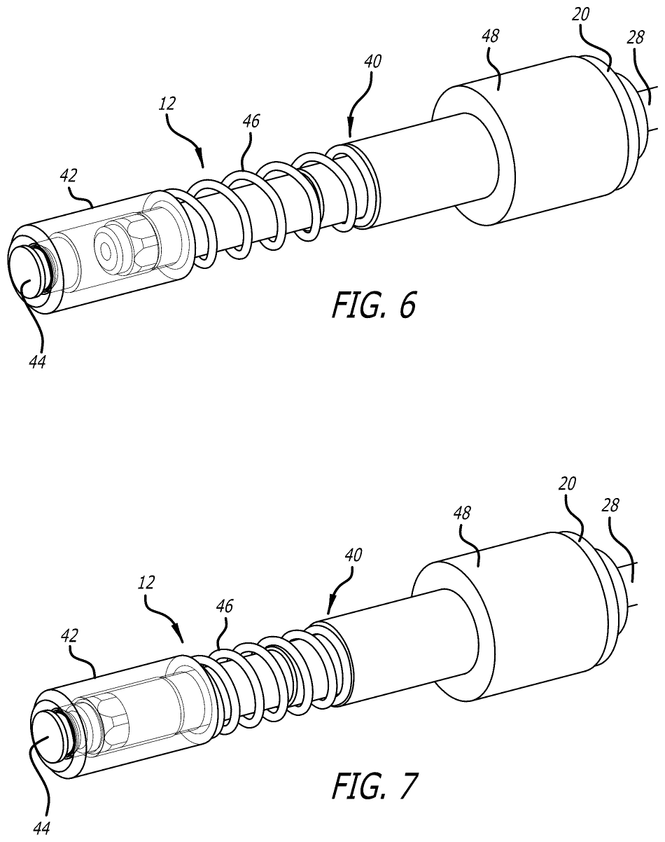

FIGS. 6 and 7 provide alternative views of the sliding movements shown in FIGS. 4 and 5. From the transparency applied to the ferrule 42 in these views, the biasing action of the ferrule 42 relative to the probe shaft 40 is apparent. The spring 46 or other biasing element that is used can be chosen to calibrate a desired contact force between the sensing element 44 and the measured object 14.

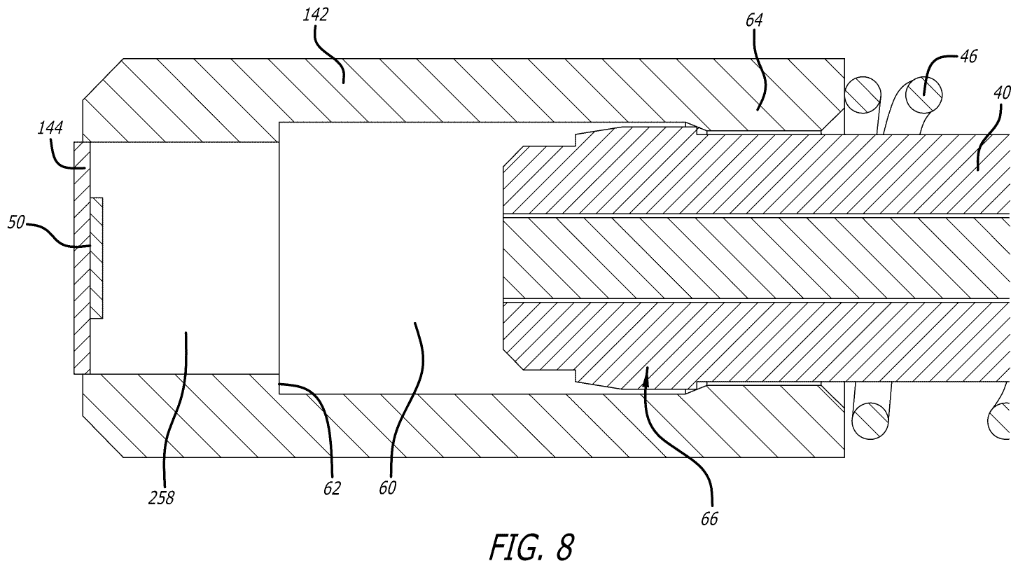

As discussed above, the configuration of the sensing probes 12 as shown in FIGS. 1-7 is only one suitable configuration for an application such as that shown in FIG. 1. Various other configurations are possible for different applications, production volumes, manufacturing techniques available, etc. For example, as shown in FIG. 8, an integrated ferrule 142 and sensing element 144 can be provided using a single component. In this example, the sensing material 50 can be positioned in the same location as the embodiments described above, and the shoulder 62 and second chamber 60 can be similar to that shown in FIG. 3. As a result of the integrated configuration of the ferrule 142 and the sensing element 144, a modified first chamber 258 does not include the lip 54 and opening 56 of FIG. 3, potentially simplifying manufacturing. The integrated configuration of sensing element 144 may be particularly suitable for high-volume production where injection molding techniques are economical. In contrast, the lower-volume production where the snap-in sensing element 44 of FIG. 3 may be preferred where adaptability is desirable. It can be appreciated that the probe shown in FIG. 8 incorporates the snap-in feature provided by the head portion 66 of the probe shaft 40, and the projection 64 of FIG. 2, and details thereof need not be reiterated.

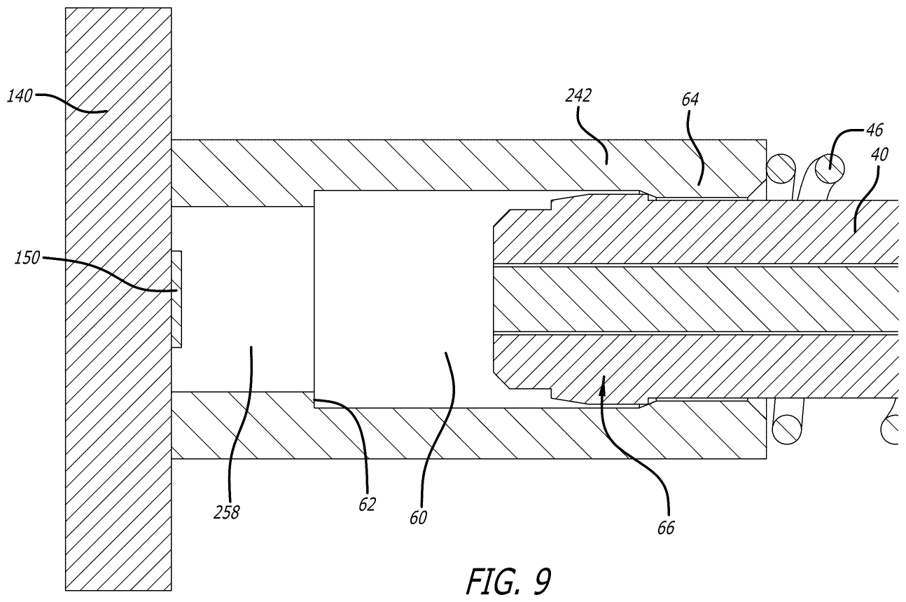

FIG. 9 illustrates another example configuration. In FIG. 9, the sensing material 150 can be coupled or otherwise integrated with the surface of object 140, or the sensing material 150 can be positioned on the inner surface of a ferrule 242 coupled to or integrated with a measured object 140 (not shown). It can be appreciated that the snap-in feature provided by the head portion 66 of the probe shaft 40 and the projection 64 would also remain unchanged in the configuration shown in FIG. 9, and details thereof need not be reiterated.

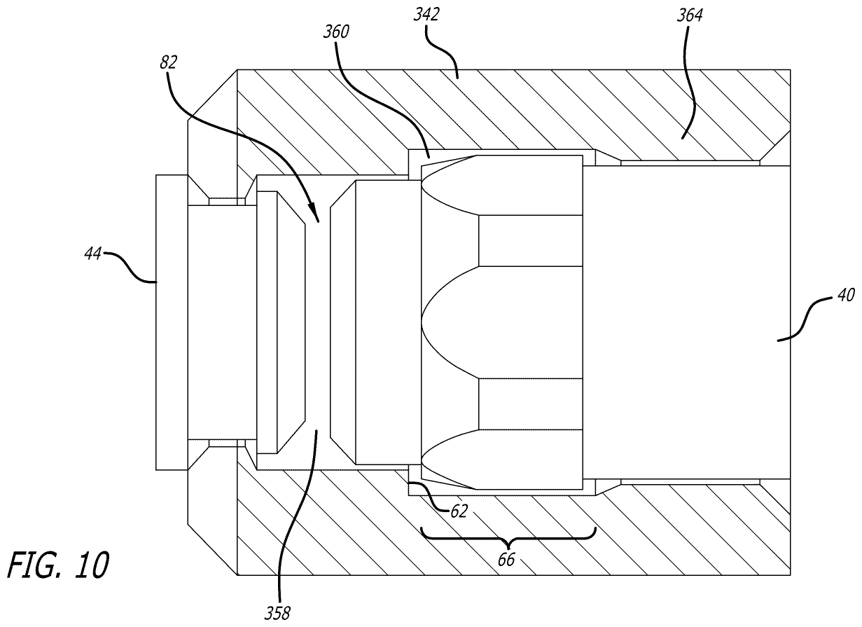

In yet another configuration shown in FIG. 10, a substantially static ferrule 342 is shown in which the same snap-in feature provided by the head portion 66 of the probe shaft 40 and the projection 364 is provided with a shorter second chamber 360. The shoulder 62 between the first chamber 358 and shorter second chamber 360 operate in a similar manner to that described above, with the head portion 66 being relatively fixed once inserted. In this configuration, a spring (e.g., spring 46 of FIG. 2) or other biasing member is not required and the configuration may be suitable in applications where contact force from such a mechanism is not required or desired. It can be appreciated that intermediate chamber lengths between what is shown in FIGS. 1-10 are contemplated. It is also appreciated, with respect to FIGS. 1-9, that different biasing members can be chosen according to a selected chamber length.

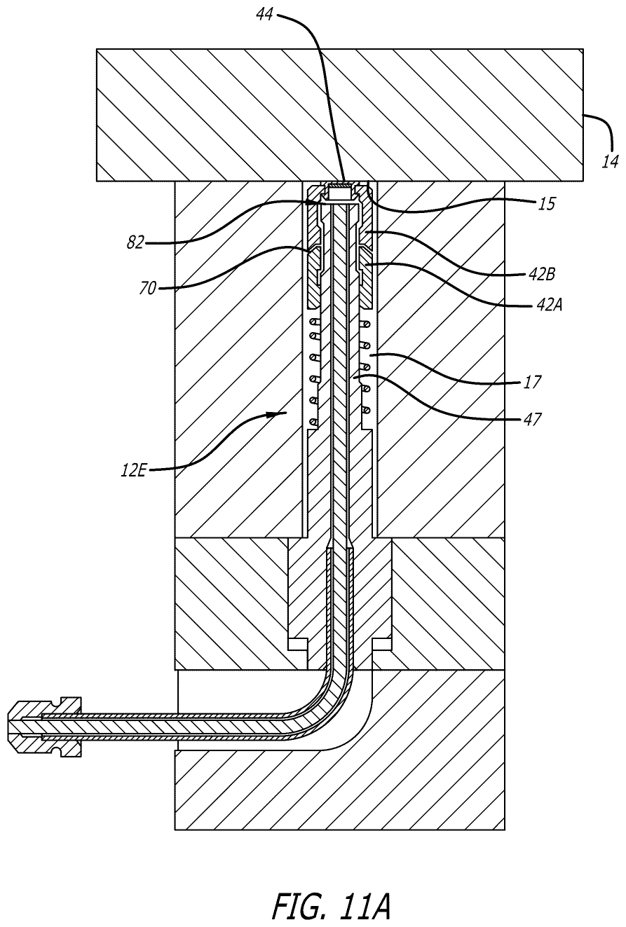

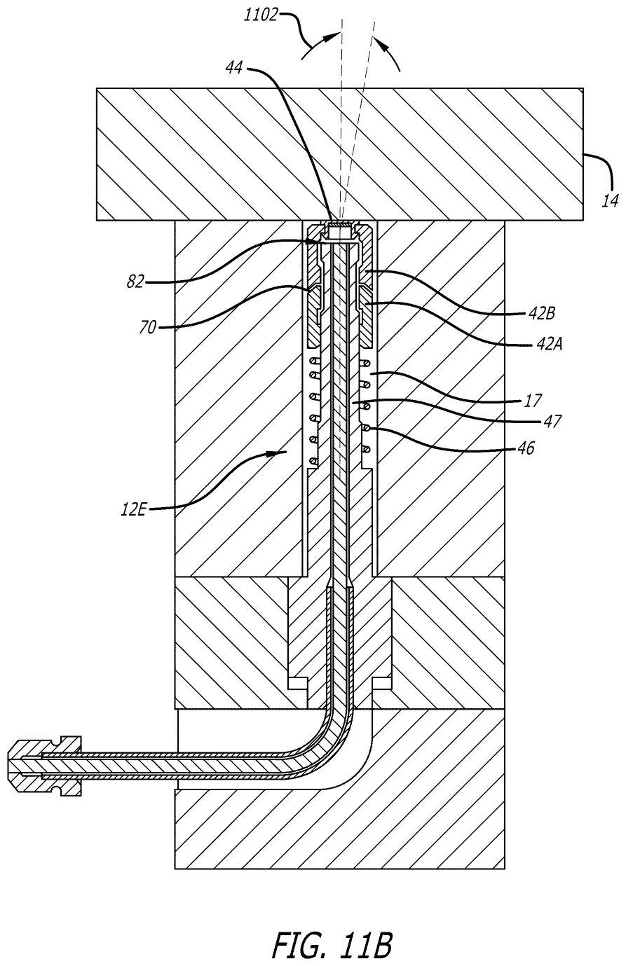

FIG. 11 illustrates another example temperature probe 12E, with a multi-part ferrule including ferrule parts 42A, 42B. In the shown embodiments, the ferrule includes a sliding ferrule part 42A and a rotating ferrule part 42B. The sliding ferrule part 42A can slide, and the rotating ferrule part 42B can rotate, with respect to the main body 47. Sliding ferrule part 42A and rotating ferrule part 42B are coupled together using a ball joint 70. In various example embodiments, other types of joints may be used to enable the ferrule part connected to the sensing element 44 to adjust, thereby facilitating increased contact area between the sensing element 44 and the exposed surface 15 of the object 14.

Referring now to FIG. 11B, temperature probe 12E is shown in an adjusted configuration. In FIG. 11B, the ferrule part 42A has been displaced by the spring 46 towards the object 14, so as to have an adjusted position relative to part 42B. Part 14B adjusts within the passage 17 to be other than colinear with the optical axes of the main body 47. In FIG. 11B, an angle 1102 between the sensing element 44 and the optical axes of the main body 47 represents the adjustment. It is noted that angle 1102 is shown intentionally exaggerated in FIG. 11B, to promote visual clarity. In various example embodiments, the angle 1102 is less than about 5 degrees, or less than about 3 degrees, or less than about 1 degree.

In various example embodiments, the rotating ferrule part 42B and the sliding ferrule part 42A have at least one snap or thread or other fastening feature that allows for installation to the main body 47 and then constrains the ferrule parts 42A, 42B to the main body 47 after installation.

An adjustable ferrule, such as ferrule 42 shown in FIGS. 11A and 11B, can promote contact between the sensing element 44 and the surface 15 of the object 14, while at the same time maintaining a gap 82 to limit thermal conductivity between the sensing element 44 and the main body 47 and the probe 12E.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the above principles have been described with reference to certain specific examples, various modifications thereof will be apparent to those skilled in the art as outlined in the appended claims.

1. A fiber optic sensing probe, comprising:
a probe shaft having a first portion and a second portion, wherein the first portion includes a first projection formed thereon, wherein the probe shaft is configured to receive a fiber optic cable therein;
a ferrule having a second projection formed therein, the second projection cooperating with the first projection to prevent the ferrule and the probe shaft from uncoupling from an assembled configuration;
a biasing member configured to bias the ferrule away from and encouraging displacement between the ferrule and the second portion of the probe shaft; and
a sensing element positioned at a distal end of the ferrule proximate to a surface to be measured, the sensing element configured to receive excitation light from the fiber optic cable and to emit light proportional to a temperature of a surface of a measured object.

2. The fiber optic sensing probe of claim 1, wherein the sensing element snap-in fits with, or comprises threading complementary to threading proximate to, an opening of the ferrule.

3. The fiber optic sensing probe of claim 2, wherein the opening of the ferrule has a chamfered opening to facilitate the snap-in fit of the sensing element.

4. The fiber optic sensing probe of claim 1, wherein the second projection comprises a chamfered surface to provide a snap-in fit with the first projection.

5. The fiber optic sensing probe of claim 1, wherein the ferrule includes a first chamber and a second chamber formed therein, the first chamber being from proximate to the sensing element, such that the first chamber and the second chamber, define a first shoulder, the first shoulder preventing the first potion of the probe shaft from contacting the sensing element.

6. The fiber optic sensing probe of claim 5, wherein a minimum distance between the sensing element and the probe shaft is defined by the first shoulder.

7. The fiber optic sensing probe of claim 1, wherein the second projection comprises an inner chamfer to interface with a third shoulder formed on the first portion to impede disassembly of the probe shaft and the ferrule.

8. The fiber optic sensing probe of claim 1, wherein the ferrule or the sensing element is coupled to the surface to be measured.

9. The fiber optic sensing probe of claim 1, wherein the second portion of the probe shaft engages a seal to form a vacuum seal between the probe shaft and ambient exterior pressure.

10. The fiber optic sensing probe of claim 9, wherein the second portion of the probe shaft is separable from the first portion.

11. The fiber optic sensing probe of claim 1, wherein the ferrule comprises at least a first ferrule part and a second ferrule part different from the first ferrule part.

12. The fiber optic sensing probe of claim 11, wherein the first ferrule part can rotate with respect to the second ferrule part, or rotate with respect to the probe shaft.

13. The fiber optic sensing probe of claim 1, further comprising a seal, the seal interacting with a wall and the probe shaft to generate a vacuum seal.

14. The fiber optic sensing probe of claim 1, wherein the sensing element comprises of one or more of diamond, aluminum, copper, gold, nickel or nickel alloy, aluminum nitride, and silicon carbide.

15. The fiber optic sensing probe of claim 1, wherein a contact area between the sensing element and the ferrule is less than 2 mm², or less than 1 mm², or less than 0.5 mm², or less than 0.25 mm².

16. The fiber optic sensing probe of claim 1, wherein the sensing element has a thermal conductivity greater than 20 W/m−1K, or greater than 150 W m−1/K, or greater than 225 W m−1/K, or greater than 300 W m−1/K.

17. The fiber optic sensing probe of claim 1, wherein the sensing element comprises an interior surface configured to interact with light received from the fiber optic cable to measure a temperature of the surface to be measured.

18. A fiber optic temperature sensing system comprising:
a probe body comprising:
a base portion;
a probe body extending from the base portion and terminating at a head portion;
a passage through the base portion and the probe body;
a fiber optic cable positioned within the passage;
at least one ferrule having a first opening at a first end, the first opening providing a snap-in or threaded-in fit with the head portion of the probe body;
a biasing member positioned to apply a biasing force to the at least one ferrule towards a surface to be measured, and
a sensing element positioned at a second end of the at least one ferrule opposite the first end of the at least one ferrule, the sensing element including a sensing material configured to receive excitation light from the fiber optic cable.

19. The fiber optic temperature sensing system of claim 18, wherein the sensing material is coupled to the surface to be measured.

20. (canceled)

21. (canceled)

22. (canceled)

23. (canceled)
